(19) United States
(12) Patent Application Publication
(10) Pub. No.: US 2026/0288531 A1
(43) Pub. Date: Sep. 24, 2026

(54) OPTIMIZING AN OPERATION ON TENSORS WITH RESPECT TO A PROCESSING DEVICE

(71) Applicant: Microsoft Technology Licensing, LLC, Redmond, WA (US)

(72) Inventors: Wei CUI, Beijing (CN); Jilong XUE, Beijing (CN)

(73) Assignee: Microsoft Technology Licensing, LLC, Redmond, WA (US)

(21) Appl. No.: 19/475,830

(22) PCT Filed: Jun. 10, 2024
(86) PCT No.: PCT/US2024/033180

§ 371 Date: Oct. 16, 2025

(30) Foreign Application Priority Data
Jun. 12, 2023 (CN) 202310694151.0

(51) Int. Cl. G06F 9/50; G06F 9/445

(52) U.S. Cl. CPC G06F 9/5055; G06F 9/44505

(57) ABSTRACT

A scheme of optimizing an operation on tensors for a processing device is provided. In this scheme, based on a size of a target tensor, a target window size is determined for a target operation associated with the target tensor to be processed on a processing device. At least one data block is determined based on the target window size and the target tensor. A set of elements included in the at least one data block cover at least the target tensor. For each data block, at least one predetermined task corresponding to the target operation and target window size are performed based on a position of each element of the data block in the target tensor. These predetermined tasks are precompiled to achieve the target operation. In this way, for various types of processing devices, a universal and efficient scheme may be implemented for tensors with different sizes.

### BACKGROUND

Deep neural networks (DNNs) are developing rapidly and have been applied or have potential applications in various fields. This greatly increases the need to run a DNN on various hardware accelerators such as a central processing unit (CPU), a graphic processing unit (CPU), and a tensor processing unit (TPU). DNN computations may usually be abstracted as computationally intensive operators for tensors, such as matrix multiplication, and may be implemented as kernels running on hardware accelerators. Therefore, optimizing an operation on tensors can advantageously improve training and inference efficiency of DNN.

### SUMMARY

According to implementations of the present disclosure, a scheme for optimizing an operation on tensors is proposed. In this scheme, based on a size of a target tensor, a target window size is determined for a target operation associated with the target tensor to be processed on a processing device. At least one data block is determined based on the target window size and the target tensor. A set of elements comprised in the at least one data block cover at least the target tensor. For each data block, at least one of a plurality of predetermined tasks corresponding to the target operation and the target window size are performed based on a position of each element of the data block in the target tensor. These predetermined tasks are precompiled for the processing device to achieve the target operation. Implementations of the present disclosure enable processing tensors with non-fixed sizes on the processing device, while avoiding the need for intensive code generation and compilation. In this way, for various types of processing devices, an efficient code execution scheme in a form of a universal runtime may be implemented for tensors with different sizes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a block diagram of an example environment in which multiple implementations of the present disclosure can be implemented;

FIG. 2 shows a schematic diagram of an example architecture for executing a target operation according to some implementations of the present disclosure;

FIGS. 3A to 3D show multiple examples using primitive tasks to process tensors according to some implementations of the present disclosure;

FIG. 4 shows a schematic diagram of the variation of primitive task allocation with computational sizes according to some implementations of the present disclosure;

FIG. 5A shows an example of predetermining an optimized window size by sampling according to some implementations of the present disclosure;

FIG. 5B illustrates an example of a mapping table predetermined by sampling according to some implementations of the present disclosure;

FIG. 6 shows a flowchart of a process of processing tensors according to some implementations of the present disclosure; and

FIG. 7 shows a schematic block diagram of an electronic device capable of implementing multiple implementations of the present disclosure.

### DETAILED DESCRIPTION

The present disclosure will now be described with reference to various example embodiments. It should be appreciated that description of those embodiments is merely to enable those skilled in the art to better understand and further implement the present disclosure and is not intended for limiting the scope disclosed herein in any manner.

As used herein, the term “includes” and its variants are to be read as open-ended terms that mean “includes, but is not limited to.” The term “based on” is to be read as “based at least in part on.” The term “one example embodiment” and “an example embodiment” are to be read as “at least one example embodiment.” The term “one example embodiment” and “an embodiment” are to be read as “at least one example embodiment.” The term “another embodiment” is to be read as “at least one further embodiment.” The term “first,” “second” or the like can represent different or the same objects. Other definitions, either explicit or implicit, may be included below.

It should be noted that the titles of any sections/sub sections provided in this article are not restrictive. This article describes various implementations throughout, and any type of implementation can be included under any section/sub section. In addition, the implementation described in any section/sub section can be combined in any way with any other implementation described in the same section/sub section and/or different sections/sub sections.

As used in this article, a set of elements, a group of elements, or similar expressions can include zero, one, or more such elements. The group of elements can be ordered or unordered. For example, a “set of separation lines” can include zero, one, or more separation lines. As used in text, a sequence of elements or similar expressions can include one or more such elements, and the elements in the sequence are ordered.

As used herein, the term “model” may learn a correlation between a corresponding input and output from training data, so that a corresponding output may be generated for a given input after a training is completed. Model generation may be based on machine learning technology. Deep learning is a machine learning algorithm that uses multiple layers of processing units to process input and provide corresponding output. A neural network model is an example of a deep learning-based model. In this article, a “model” may also be referred to as a “machine learning model”, a “learning model”, a “machine learning network”, or a “learning network”, and these terms are used interchangeably in this article.

As used herein, the term “tensor” may have any suitable number of dimensions, and each dimension may have any suitable length. For example, a tensor may be a one-dimensional tensor (that is, a vector), a two-dimensional tensor (that is, a matrix), a three-dimensional tensor, or a tensor with any other number of dimensions. As used herein, “tensor size”, “tensor shape”, or similar expressions refer to the length of a tensor in one or more of its dimensions.

### Example Environment

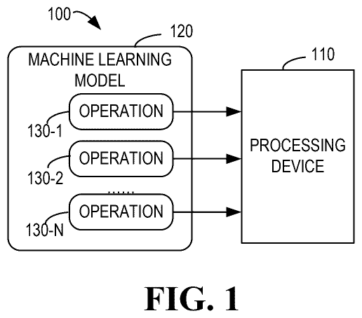

FIG. 1 shows a schematic diagram of an example environment 100 in which implementations of the present disclosure can be implemented. In the environment 100 of FIG. 1, a machine learning model 120 is run on a processing device 110 to obtain inference results or train the machine learning model 120. The processing device 110 may be any hardware system or hardware platform with computational power. The processing device 110 may be any suitable type of universal processing device or specialized processing device. Examples of universal processing devices include but are not limited to a CPU, a GPU, a field programmable gate array (FPGA), and so on. Examples of specialized processing devices include but are not limited to an accelerated processor (APU), a TPU, a neural network processing unit (NPU), or other existing or future developed artificial intelligence (AI chips). It can be understood that such accelerated processing resources are mainly used to improve the computing speed of AI related applications.

As shown in FIG. 1, the machine learning model 120 may be abstracted as one or more operations 130-1, 130-2, . . . , 130-N for tensors, which are also collectively or individually referred to as an operation 130, where N is a positive integer. The operation 130 may include various suitable universal calculations or operations, for example but not limited to matrix multiplication, convolution, accumulation, transpose, or the like. Alternatively, or in addition, the operation 130 may include a customized calculation or operation, such as padding, convolutional padding, wildcard matching, or the like.

The operation 130 of the machine learning model 120 is compiled into machine executable code, also known as a kernel. When a certain operation 130 with various calculation sizes is requested, a calculation result is obtained by an implementation of running the operation 130 on the processing device 110 at runtime.

It should be understood that the description of the structure and functionality of the environment 100 is only for illustrative purposes and does not imply any limitations on the scope of the present disclosure. In the embodiments of the present disclosure, the operations and customized computations performed by the processing device 110 may come from other types of models, algorithms, or conventional data processing services, which are not limited to machine learning models.

Taking the widely used deep neural network (DNN) as an example, DNN operator needs to handle tensors with any size. There are generally two types of solutions for running DNN on a processing device. In one solution, a tensor compiler generates device-specific kernels on demand by tuning. This solution generates a large number of kernel configurations for a given DNN model, compiles each kernel configuration into an executable kernel, and evaluates the performance of these kernels on a target processing device to find an optimized configuration. This solution is a static solution which generates an optimized solution for tensors with a specific size. If the size of a tensor changes, it needs to be re-optimized. Therefore, this solution is efficient for static DNNs with known tensor sizes, but it is not suitable for more dynamic models. That is to say, although this solution is efficient, it is not universal.

The other solution aims to manually implement code that can handle universal “tensor size” situations. This makes optimizing tensor operations difficult and time costly. That is to say, although this solution is universal, it is not efficient.

Although these solutions already exist, there are still some issues. A major issue is that all these solutions require generating and compiling a new kernel for each of new tensor sizes. In some cases, for example on a processing device without a suitable compiler, or in an application where compilation delays are unacceptable, this may be a limiting factor. Another issue of these solutions is that for “a scheme designed to estimate a good kernel configuration quickly and generate new binary code in real time with each of new given tensor sizes”, the quickly estimated kernel configuration may not reflect the performance of the final kernel accurately. This is because when compiled by different compilers, the same kernel configuration or even the same kernel code may generate very different binary executable files, or multiple logical equivalent code of the same compiler and the same kernel configuration may also generate very different binary executable files.

To address each of the above issues, the implementations of the present disclosure provide a scheme of optimizing an operation on tensors with respect to a processing device. According to the implementations of the present disclosure, a plurality of primitive tasks for performing a target operation are pre-optimized and precompiled for the processing device. Each primitive task processes tensors with a specific size (also referred to as a window size). Each primitive task has a plurality of implementations, also known as a plurality of predetermined tasks. Each predetermined task may have different vectorization degrees and region-specific fast computing preferences for processing different types of data blocks at runtime.

At runtime, firstly, a target window size is determined for a target tensor to be processed, and the target tensor is divided into at least one data block with the target window size. Then, a pre-optimized and precompiled primitive task for the target window size is performed for each data block, and at least one of the plurality of predetermined tasks of the primitive task is performed according to a position of an element comprised in the data block in the target tensor. For each tensor position, a predetermined task with the best performance for the region is usually chosen to execute.

In the implementations of the present disclosure, a primitive task that may be shared by different tensor sizes is optimized through ahead of time (AT) compilation, and the precompiled primitive tasks are used at runtime to achieve the target operation. Therefore, the implementations of the present disclosure support the processing of tensors with non-fixed size on the processing device, while avoiding optimization overhead for intensive code generation and compilation at runtime. In this way, for various types of processing devices, a universal and efficient solution of “pre-optimization ahead of time and immediate execution at runtime” may be achieved for tensors with different sizes.

The example embodiments of the present disclosure are described below with reference to the accompanying drawings.

### Example Architecture

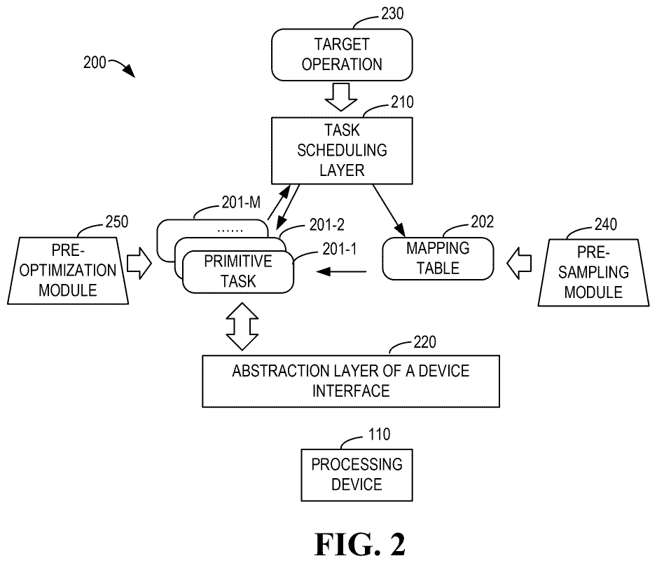

FIG. 2 shows a schematic diagram of an example architecture 200 for performing the target operation according to some implementations of the present disclosure. Overall, the architecture 200 comprises pre-executed parts, including a pre-optimization module 250 and a pre-sampling module 240. The architecture 200 also comprises runtime parts, including a processed target operation 230 associated with the target tensor, a task scheduling layer 210, and an abstraction layer 220 of a device interface of the processing device 110. The target operation 230 may be an example of the operation 130. The target tensor may be an input tensor or an output tensor of the target operation 230.

The pre-optimization module 250 is configured to pre-optimize and precompile one or more primitive tasks 201-1, 201-2, . . . , 201-M for the processing device 110, which also collectively or individually referred to as a primitive task 201, where M is a positive integer. Each primitive task 201 corresponds to an operation and a tensor size (also referred to as a window size). The tensor size may be a size of the input tensor of the task or a size of the output tensor. In other words, each primitive task 201 is precompiled for the processing device 110 to perform a corresponding operation for a corresponding window size. For example, a certain primitive task may be pre-optimized and precompiled to perform matrix multiplication on at least two input matrices, to output a matrix with a size of P×Q. In this example, the primitive task corresponds to the operation “matrix multiplication” and the window size P×Q.

At runtime, the window size to be used is determined for the target tensor, which is also referred to as the target window size. Then, the target tensor is divided into at least one data block according to the target window size. Each data block is executed by an instance of the primitive task corresponding to the target window size and the target operation 230.

The pre-optimization module 250 may optimize the primitive task 201 for the processing device 110 using any suitable method. For example, an automatic tuning-based method may be used to find an optimized kernel configuration for the processing device 110 and a corresponding window size. For example, a configuration generator may be used to recommend an efficient configuration for the corresponding window size. Considering that each primitive task is pre-generated for one-time, the tuning cost is also one-time.

In some implementations, a plurality of primitive tasks corresponding to a plurality of window sizes (also referred to as candidate window sizes) may be pre-optimized and precompiled for a same operation. For example, for matrix multiplication, a plurality of primitive tasks corresponding to window sizes 32×32, 64×64, 128×128 may be pre-optimized and precompiled respectively. In such an implementation, during a process of processing the target operation 230 at the runtime, the target window size for the target tensor may be selected from these candidate window sizes based on the size of the target tensor targeted by the target operation 230.

In some implementations, if tensor sizes to be processed are limited, then for each possible tensor size, a window size suitable for the tensor size may be predetermined. Therefore, at runtime, a predetermined window size may be selected as the target window size based on the size of the target tensor.

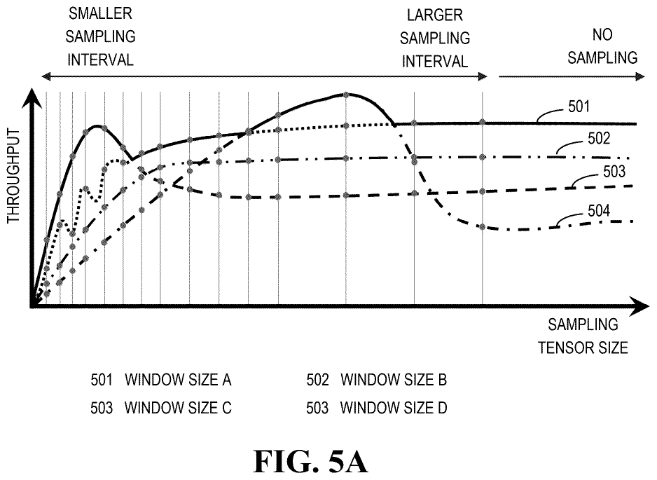

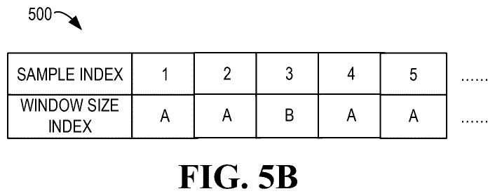

In some cases, the tensor sizes to be processed may be diverse or even infinite. In view of this, in some implementations, the architecture 200 may also include the pre-sampling module 240, which is configured to determine an optimized window size separately for a plurality of sampling tensor sizes. At runtime, according to the size of the target tensor, a sampling tensor size that matches or is close to the size of the target tensor may be selected from the plurality of sampling tensor sizes. The optimized window size predetermined for the selected sampling tensor size may be determined as the target window size. In this way, universality and flexibility may be further improved. A recording process of determining the most efficient primitive task from the sampling tensor sizes by the pre-sampling module 240 is also one-time ahead of time. Such embodiments are further described below with reference to FIGS. 5A and 5B.

The sampling tensor size and the corresponding optimized window size may be maintained in any suitable way, such as using a mapping table 202. The key of the mapping table 202 may be the sampling tensor size, and the value may be the corresponding optimized window size.

The task scheduling layer 210 is configured to schedule the target operation 230 as a primitive task automatically. In addition, the task scheduling layer 210 may further support customized scheduling strategies among different operations. For example, a user may define a scheduling order, a scheduling throttling, or the like among different operations in a DNN model through the task scheduling layer 210.

The abstraction layer 220 provides a unified interface for launching a primitive task. Through this interface, a group of instances of a same primitive task may be launched, and each instance is used to process a part of the target tensor, for example, a data block with the target window size. For some advanced processing devices (for example, CPUs), multiple primitive tasks designed for different target operations may be combined into a larger composite task to be executed simultaneously with an advantage of higher device utilization.

The example architecture 200 is described above, and it should be understood that the various components of the architecture 200 are only illustrative and do not have any limitations. Furthermore, it should be understood that specific values of tensor sizes and window sizes listed throughout the present disclosure are only illustrative and are not intended to limit the scope of the present disclosure. The implementation of the present disclosure may be applied to any tensor size and window size.

### Example Primitive Task

As mentioned above, each primitive task 201 corresponds to an operation and a window size. That is to say, a primitive task corresponding to a certain operation is a basic computational unit of the operation, which processes the portion of the target tensor with the corresponding window size (that is, the data block with the corresponding window size). For example, for DNN, the primitive task may be a basic computational unit of the DNN operator, which processes the portion of the output tensor with the corresponding window size.

Considering that the target tensor may be of any size or that values of elements of the target tensor have a certain feature distribution (such as examples of the filling operation or the block sparse matrix described below), data blocks obtained by dividing the target tensor using the determined window size may be of different types. Therefore, each primitive task 201 may have a plurality of predetermined tasks, each of which may be used to process a type of data block. These predetermined tasks may have different execution efficiency. In particular, in some implementations, these predetermined tasks may have different vectorization degrees.

Depending on specific implementations or differences in program execution interfaces constrained by processing devices (for example, single instruction multiple data SIMD processors, multiple instruction multiple data MIMD processors, or the like), the plurality of predetermined tasks included in each primitive task may be compiled together into a kernel, or each predetermined task may be compiled into a kernel respectively. The implementation of the present disclosure is not limited in this regard.

Accordingly, at runtime, for each data block, at least one of the plurality of predetermined tasks is executed according to positions of elements of the data block in the target tensor. For example, the type of the data block may be determined according to positions of elements of the data block in the target tensor, and then a predetermined task corresponding to that type of the plurality of predetermined tasks may be executed.

In some implementations, in order to determine which predetermined task to perform, it may be based on a predetermined boundary associated with the target tensor. If respective elements included in a certain data block do not cross the predetermined boundary, a predetermined task with high efficiency in the plurality of predetermined tasks may be performed for the data block, for example, a highly vectorized predetermined task. If respective elements included in a certain data block cross the predetermined boundary, a predetermined task with low efficiency may be performed for the data block, for example, a predetermined task with a low vectorization degree or even no vectorization. In the following, for illustrative purposes only, data blocks including elements that do not cross the predetermined boundary are referred to as interior blocks, and data blocks including elements that cross the predetermined boundary are referred to as border blocks.

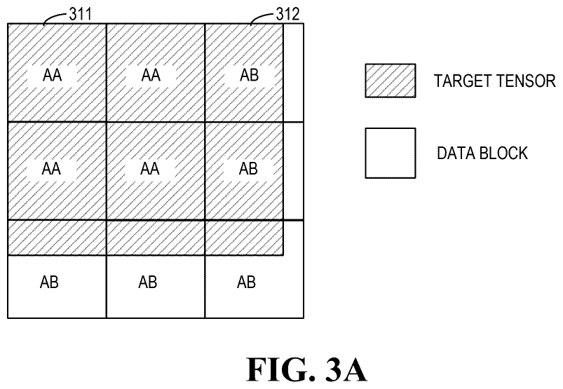

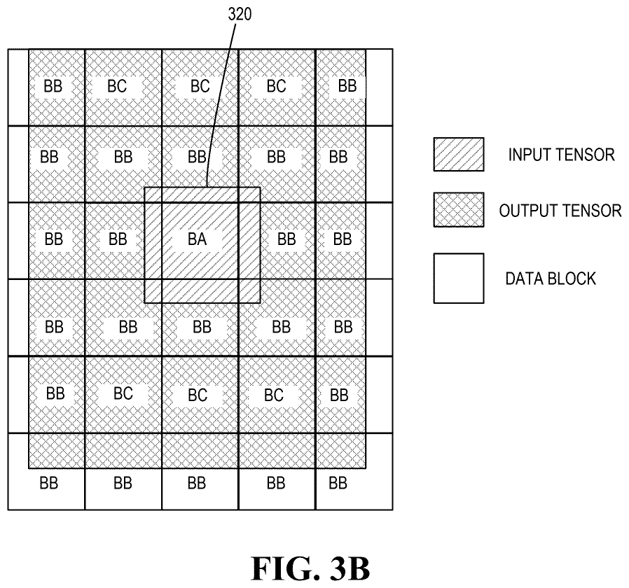

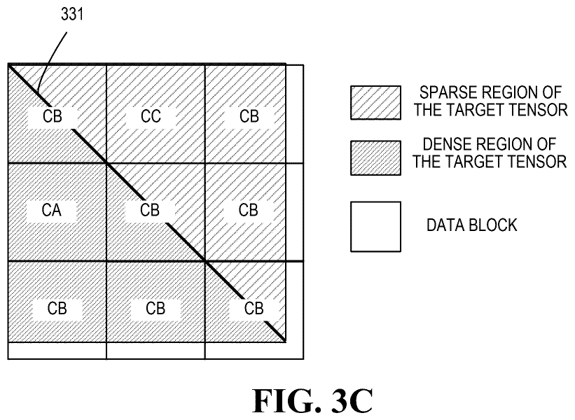

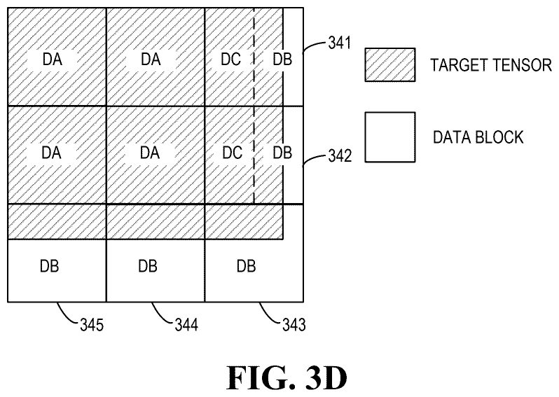

The predetermined boundary is associated with changes in the elements of the target tensor. In some implementations, the predetermined boundary may include one or more borders of the target tensor. An example is described with refer to FIG. 3A, which illustrates an example universal basic partitioning. In this example, the target tensor may be an output tensor of General Matrix Multiply (GEMM), and the predetermined boundary is a border of the target tensor, which is a column with the highest column index and a row with the highest row index. According to the determined target window size, the target tensor is divided into 3×3 data blocks. Among these data blocks, data blocks identified as AA (for example, a data block 311) are data blocks that do not cross the border, therefore data blocks identified as AB (for example, a data block 312) are data blocks that cross the border. Accordingly, a vectorized predetermined task AA is performed for the data blocks identified as AA; a non-vectorized predetermined task AB is performed for the data blocks identified as AB.

Alternatively, or in addition, in some implementations, the predetermined boundary may include a boundary for distinguishing predetermined operations (also referred to as actions) applied by the target operation to elements in the target tensor. That is to say, in the execution of the target operation, specific operations applied to elements located on different sides of the boundary are different. An example is described with reference to FIG. 3B. In this example, the target operation is to fill the input tensor with the output tensor. The predetermined boundary includes two types of boundaries. One type of boundary is the border of the output tensor, which is a column with the smallest column index, a column with the largest column index, and a row with the largest row index. The other type of boundary 320 is used to distinguish predetermined operations applied to elements. Specifically, the operation applied to elements within the boundary 320 is to copy the input tensor, and the operation applied to elements outside the boundary is padding. Data blocks identified as BA and BC are data blocks that do not cross the predetermined boundary, therefore vectorized predetermined tasks BA and BC are performed for these data blocks. Data blocks identified as BB are data blocks that cross the predetermined boundary; therefore, a non-vectorized predetermined task BB is performed for these data blocks. Because the predetermined task BB needs to distinguish and process a variety of different computational details in a fine-grained manner, the predetermined task BB may also be used to compute areas identified as BC and BA, but the efficiency is often not as good as predetermined tasks BC and BA.

In some implementations, the predetermined boundary may include a boundary associated with distribution of values of elements in the target tensor. In other words, the target tensor may be divided into different regions by such boundary, and values of elements in different regions have different distribution characteristics. As an example, sparsity of tensors may be common in the DNN. For example, a tensor may be divided into a sparse region and a dense region, according to whether values of elements are zero. An example is described with reference to FIG. 3C, where a predetermined boundary 331 divides the target tensor into a sparse region and a dense region, and the predetermined boundary also includes a border of the target tensor, that is, a column with the highest column index and a row with the highest row index. Data blocks identified as CA and CC do not cross the predetermined boundary 331, nor do they cross the border. Therefore, vectorized predetermined tasks CA and CC are performed for these data blocks. Data blocks identified as CB cross the predetermined boundary 331 and/or the border, therefore a non-vectorized predetermined task CB is performed for these data blocks.

From the above examples, it can be seen that for data blocks that do not cross the predetermined boundary, the vectorized task may be utilized to achieve efficient processing, while for data blocks that cross the predetermined boundary, it may fall back to use a conservative implementation. It can be understood that for tensors, especially those with larger dimensions, the number of interior blocks is larger compared to border blocks. Therefore, a proportion of tasks with relatively low efficiency is relatively low. In this case, computational efficiency may be improved.

In some implementations, the processing of data blocks that do not cross the predetermined boundary may be further refined. For example, the predetermined boundary may divide the target tensor into different portions. Each portion may correspond to one of the plurality of predetermined tasks of the primitive task. For data blocks that do not cross the predetermined boundary, a predetermined task corresponding to the portion they are located in may be selected to perform.

As an example, reference is again made to FIG. 3B. The predetermined boundary 320 divides the target tensor into an interior area within the predetermined boundary and an external area outside the predetermined boundary 320. A predetermined task BA may be performed for data blocks identified as BA within the interior area, which may be copying the input tensor from memory. A predetermined task BC may be performed for data blocks identified as BC in the external area, which may be filling the entire data block with a certain value.

As another example, reference is again made to FIG. 3C. The predetermined boundary 331 divides the target tensor into a dense region in the lower left corner and a sparse region in the upper right corner. For data blocks identified as CA in the dense region, a predetermined task CA is performed, for example, matrix multiplication implemented in a vectorization manner. For data blocks identified as CC in the sparse region, a predetermined task CC is performed, for example, filling in predetermined values.

In this implementation, execution efficiency of various customized computations may be improved by refining the processing of data blocks that do not cross the predetermined boundary, and extracting hidden and shared local computation features within areas.

In some implementations, the processing of data blocks that cross the predetermined boundary may be further refined. For example, the data blocks may be further divided into sub-blocks that cross the predetermined boundary and sub-blocks that do not cross the predetermined boundary. A vectorized predetermined task may be performed for the sub-blocks that do not cross the predetermined boundary, and a vectorization degree of the predetermined task is less than a vectorization degree of a predetermined task performed for data blocks that do not cross the predetermined boundary. In some implementations, a non-vectorized predetermined task may be performed for sub-blocks that cross the predetermined boundary. Alternatively, in some implementations, sub-blocks that cross the predetermined boundary may be further refined, for example, the sub-blocks may be divided into a portion that crosses the predetermined boundary and a portion that do not cross the predetermined boundary.

An example is described with reference to FIG. 3D. In this example, the predetermined boundary is the border of the target tensor, which includes a column with the highest column index and a row with the highest row index. Data blocks identified as DA do not cross the predetermined boundary, therefore a fully vectorized predetermined task DA, such as matrix multiplication, is performed for these data blocks. Data blocks 341-345 cross the predetermined boundary. For data blocks 343-345, the number of elements within the predetermined boundary does not exceed half of the data blocks. Therefore, for data blocks 343-345, no further refinement may be performed, and instead, a non-vectorized predetermined task DB may be performed. Data blocks 341 and 342 are refined. The data blocks 341 and 342 are divided into two sub-blocks, respectively. For sub-blocks identified as DC that do not cross the predetermined boundary, a semi-vectorized predetermined task DC may be performed. For sub-blocks identified as DB that cross the predetermined boundary, a non-vectorized predetermined task DB may be performed.

Sub-blocks and/or data blocks identified as DB may be further refined. For example, a predetermined task of optimizing and compiling quarter vectorization may be predetermined for processing a portion of sub-blocks and/or data blocks identified as DB.

Example primitive tasks are described above. Each primitive task may have multiple implementations, that is, the plurality of predetermined tasks. In these predetermined tasks, tasks corresponding to data blocks and/or sub-blocks that do not cross the predetermined boundary may be optimized to improve the efficiency of main computations, while tasks corresponding to data blocks and/or sub-blocks that cross the predetermined boundary are used to ensure continuity of performance. In this way, in the implementation of the present disclosure, the continuity of computational performance may be ensured when a computation size changes. In the aforementioned example, the column with the highest column index and the row with the highest row index are set to the predetermined boundary, but it should be understood that this is only illustrative. Other borders may also be set as the predetermined boundary. For example, a column with the smallest column index and a row with the smallest row index may be set to the predetermined boundaries.

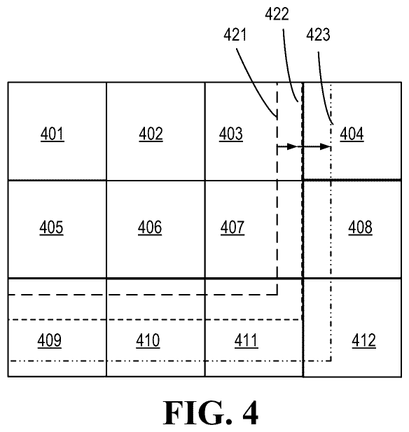

FIG. 4 is used as an example for illustration. For ease of explanation, task A is used to represent a predetermined task performed for data blocks that do not cross the border, and task B is used to represent a predetermined task performed for data blocks that cross the border. In a case where the target tensor has a border 421, the task A is executed for data blocks 401, 402, 405, and 406, and the task B is executed for data blocks 403, 407, 409, 410, and 411. That is to say, performing the target operation on the target tensor requires 4 task A and 5 task B. For a case where a border is between the border 421 and a border 422, the performed predetermined task has no change.

If the border is extended to the border 422, task A is performed for data blocks 401, 402, 403, 405, 406, and 407, and task B is performed for data blocks 409, 410, and 411, that is, 6 task A and 3 task B will be performed. Furthermore, if the border is extended to a border 423, task A is performed for data blocks 401, 402, 403, 405, 406, and 407, and task B is performed for data blocks 404, 408, 409, 410, 411, and 412. That is, 6 task A and 6 task B will be performed.

From the above examples, it can be seen that when the computation size continues to increase until it exceeds the window size of the primitive task, a new instance of the primitive task will be added. At the same time, the original primitive task for processing border blocks changes to processing interior blocks. This allows efficient processing of a target tensor with a larger window size.

### Selection Of Target Window Size

If the window size for dividing the target tensor is small, the target tensor will be divided into a larger number of data blocks. In this case, parallelism of data block processing may be improved, but scheduling and switching among primitive task instances of different data blocks may also incur additional overhead. If the window size for dividing the target tensor is large, the target tensor will be divided into a smaller number of data blocks. In this case, the parallelism is low, and unutilized computational resources may exist in the processing device 110. In view of this, the determination of the target window size needs to be weighed and optimized according to the processing device 110 and the size of the target tensor.

On the other hand, as mentioned with reference to FIG. 2, in some cases, the tensor sizes to be processed may be diverse or even infinite. Therefore, it is difficult to record each optimized window size in advance for all tensor sizes with infinite possibilities.

Considering the continuity of performance described above, in some implementations, the optimized window size may be predetermined for a plurality of sampling tensor sizes. In a case of processing the target tensor, a sampling tensor size that is close or matched is selected according to the size of the target tensor, and the optimized window size corresponding to the selected sampling tensor size is determined as the target window size.

In some implementations, the optimized window size may be predetermined for each sampling tensor size in the following way. In particular, a plurality of candidate window sizes may be preset, for example, 32×32, 64×64, 128×128. For each candidate window size, they have the ability to achieve the target operation (for example, a custom element) for “any tensor size”, but throughput they may achieve may vary. For each candidate window size, by measuring its performance at each sampling tensor size, throughput achieved by any window size for any sampling tensor size may be obtained. Based on corresponding throughput, an optimized window size may be selected for the sampling tensor size from these candidate window sizes. For example, a candidate window size with the highest throughput is determined as the optimized window size preferred by a specific sampling tensor size.

An example is described with reference to FIG. 5A. Each vertical line in FIG. 5A represents a sampling tensor size. For smaller tensor sizes, dense sampling is performed, while for larger tensor sizes, sparse sampling is performed. Sampling may be stopped until throughput changes relatively smoothly or even without change. Therefore, for each sampling tensor size, one or more optimized window sizes may be predetermined. It should be understood that for a same sampling tensor size, optimized window sizes for different operations may be different.

Accordingly, a mapping table 500 as shown in FIG. 5B may be constructed, which may be seen as an example of the mapping table 202. In the mapping table 500, a sample index row represents sampling tensor sizes, and a window size index row represents corresponding optimized window sizes. The mapping table 500 may be used to select the target window size for the target tensor at runtime.

At runtime, based on the size of the target tensor, a sampling tensor size that is close or matched may be selected from these sampling tensor sizes. The optimized window size for the selected sampling tensor size may be determined by searching for a mapping table such as the mapping table 500. The optimized window size may be determined as the target window size.

In some implementations, in order to select the sampling tensor size, characteristics of the processing device 110 and the target operation may be taken into account. Therefore, the sampling tensor size may be selected based further on parameters associated with the processing device 110 and the target operation. The parameters related to or associated with the processing device 110 and the target operation described here mean that their parameter values depend on the processing device 110 and the target operation.

Such parameters may include a first parameter a, which indicates a tensor size corresponding to a change in a sampling interval in these sampling tensor sizes. For example, the first parameter a may be related to a change from a smaller sampling interval to a larger sampling interval as shown in FIG. 5A. The first parameter a is used to balance the size of the mapping table and the sampling interval. Such parameters may further include a second parameter b, which indicates the maximum sampling tensor size among these sampling tensor sizes. The second parameter b may be determined by evaluating the minimum sampling tensor size at which peak throughput of the primitive task with various window sizes becomes flat.

As an example, assuming the length of the target tensor in a certain dimension is x, the sampling tensor size may be selected according to the following equation:

$$ToSample ( x ) = \{ \begin{matrix}{2}^{⌊ {log}_{2} ( x ) ⌋} , & 1 \leq x < {2}^{α} ; \\ ⌊ \frac{x}{{2}^{α}} ⌋ \cdot {2}^{α} , & {2}^{α} \leq x \leq {2}^{β} ; \\ ToSample ( {2}^{β} ) , & x > {2}^{β} ;\end{matrix} \qquad ( 1 )$$

where ToSample represents the selected sampling tensor size. At runtime, the corresponding first parameter a and second parameter b may be found according to the processing device 110 and the target operation. Then, the sampling tensor size to be selected is computed according to the equation (1). Then, the corresponding optimized window size is searched according to the mapping table. From this, the target window size may be determined.

In this implementation, the sampling tensor size is selected by considering parameters related to the processing device and the target operation, which is beneficial for finding the correctly optimized window size for the target tensor. In this way, computational efficiency may be ensured, and the best selection may be covered within the maximum size range.

### Launch Primitive Task

Assuming that for a target tensor D, the determined primitive task is t. Therefore, in order to fully cover the target tensor, the number of instances of the primitive task t to be launched may be determined by the following equation:

$$RequiredTasks ( t , D ) = {\prod }_{i = 0}^{N - 1} ⌈ \frac{{D}_{i}}{t \cdot {w}_{i}} ⌉ \qquad ( 2 )$$

where RequiredTask represents the number of instances of the primitive task t to be launched, N is the dimension size of the target tensor, Dᵢ is the length of the i^{th} dimension, and t·wᵢ is the window length of the window size corresponding to the primitive task t in the i^{th} dimension.

Therefore, at runtime, the number of instances of the primitive task may be determined. In some implementations, these instances may be launched together. In some implementations, these instances may be grouped. Instances in each group may be launched together, and different groups may be launched one after another. Launching instances of the primitive task in groups may further improve scheduling flexibility of tensor computations.

In some implementations, a pipeline for tensor processing may exist. For example, the result of the target operation performed by the processing device 110 on the target tensor may be sent to another processing device for further processing. To achieve this, data blocks or instances of primitive tasks divided by the target tensor may be divided into multiple groups, for example, at least a first group and a second group. The grouping may be implemented in any suitable way, and the implementation of the present disclosure is not limited in this regard.

Performing the predetermined task for the first set of data blocks may be first launched, and then asynchronous transmission of execution results to a further processing device downstream of the pipeline is launched. While the asynchronously transmission, performing predetermined tasks for the second group of data blocks may be launched, and then the transmission of execution results of the second group of data blocks to a further processing device may be launched. As used herein, “asynchronous transmission” means that a sending end sends data to a receiving end, and may perform other operations while waiting for the receiving end to respond. For example, while the results of the first group of data blocks are asynchronously transmitted, the processing device 110 may process the second group of data blocks.

From the perspective of instances of the primitive task, the first group of instances may be launched first, and then the execution results of the first group of instances may be asynchronously transmitted to a further processing device. Then, the second group of instances is launched and asynchronous transmission of the execution results of the second group of instances to a further processing device is launched.

In this implementation, computational tasks and communication tasks overlap in time. This may improve efficiency in a case of pipeline operation.

### Example Flow

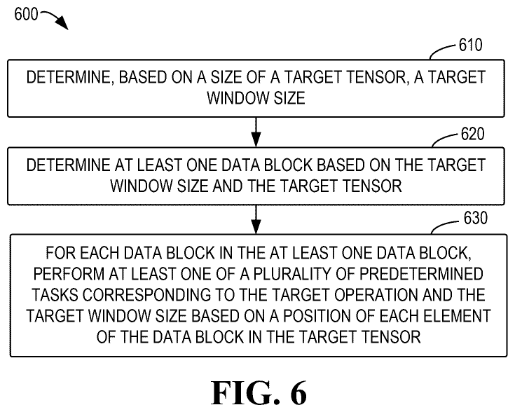

FIG. 6 shows a flowchart of a process 600 of processing tensors according to some implementations of the present disclosure. The process 600 may be implemented at a computing system included in the processing device 110.

At block 610, the computing system determines, based on a size of a target tensor, a target window size for performing a target operation associated with the target tensor on the processing device 110.

In some implementations, the computing system may select, based on the size of the target tensor, a sampling tensor size from a plurality of sampling tensor sizes. Optimized window sizes are predetermined for the plurality of sampling tensor sizes respectively. The computing system may determine an optimized window size predetermined for the selected sampling tensor size as the target window size.

In some implementations, selecting the sampling tensor size from the plurality of sampling tensor sizes is further based on a parameter associated with the processing device 110 and the target operation.

In some implementations, an optimized window size for each sampling tensor size of the plurality of sampling tensor sizes is determined by: determining, for each candidate window size of a plurality of candidate window sizes, throughput by performing, at the candidate window size, the target operation for a tensor with the sampling tensor size; and selecting, based on the throughput determined respectively for the plurality of candidate window sizes, the optimized window size for the sampling tensor size from the plurality of candidate window sizes.

At block 620, the computing system determines at least one data block based on the target window size and the target tensor. A set of elements comprised in the at least one data block cover at least the target tensor.

At block 630, for each data block in the at least one data block, the computing system performs at least one of a plurality of predetermined tasks corresponding to the target operation and the target window size based on a position of each element of the data block in the target tensor. The plurality of predetermined tasks are precompiled for the processing device 110 to perform the target operation on a tensor with the target window size.

In some implementations, the computing system may determine whether the data block comprises an element crossing a predetermined boundary associated with the target tensor; and in response to determining that the data block does not comprise an element crossing the predetermined boundary, perform, for the data block, a vectorized first predetermined task of the plurality of predetermined tasks.

In some implementations, in response to determining that the data block comprises an element crossing the predetermined boundary, the computing system may divide the data block into a first subblock that does not cross the predetermined boundary and a second subblock crossing the predetermined boundary; perform, for the first subblock, a vectorized second predetermined task of the plurality of predetermined tasks, wherein a vectorization degree of the second predetermined task is less than a vectorization degree of the first predetermined task; and perform, for the second subblock, a non-vectorized third predetermined task of the plurality of predetermined tasks.

In some implementations, the predetermined boundary divides the target tensor into different portions. The computing system may select, from the plurality of predetermined tasks, the first predetermined task corresponding to a portion where the data block is located.

In some implementations, the predetermined boundary comprises at least one of: a border of the target tensor, a boundary associated with distribution of values of elements in the target tensor, or a boundary for distinguishing predetermined operations applied by the target operation to elements in the target tensor.

In some implementations, the computing system may further divide the at least one data block into at least a first group of data blocks and a second group of data blocks; launching performing, for the first group of data blocks, at least one of the plurality of predetermined tasks respectively; launching asynchronous transmission of respective execution results of the first group of data blocks to a further processing device 110; while the asynchronous transmission, launching performing, for the second group of data blocks, at least one of the plurality of predetermined tasks respectively; and launching asynchronous transmission of respective execution results of the second group of data blocks to the further processing device.

### Example Device

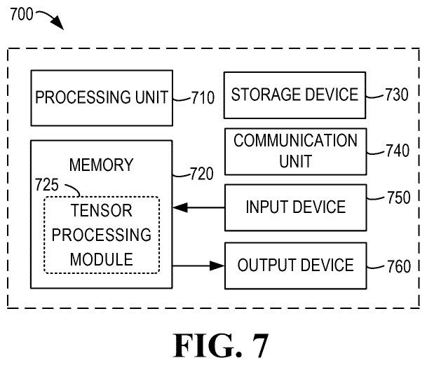

FIG. 7 illustrates a block diagram of an electronic device in which various implementations of the subject matter described herein can be implemented. It should be appreciated that the electronic device 700 shown in FIG. 1 is merely provided as an example, without suggesting any limitation to the functionalities and scope of implementations of the subject matter described herein.

As shown in FIG. 7, the electronic device 700 includes a electronic device 700 in form of a general-purpose computing device. Components of the electronic device 700 may include, but are not limited to, one or more processors or processing units 710, a memory 720, a storage device 730, one or more communication units 740, one or more input devices 750, and one or more output devices 760.

In some implementations, the electronic device 700 may be implemented as a computing device, a computing system, a server, a mainframe, and other devices with computing capabilities.

The processing unit 710 may be a physical or virtual processor and can implement various processes based on programs stored in the memory 720. In a multi-processor system, a plurality of processing units executes computer-executable instructions in parallel so as to improve the parallel processing capability of the electronic device 700. The processing unit 710 may comprise a central processing unit (CPU), a graphical processing unit (GPU), a microprocessor, a controller and/or a microcontroller or the like. The processing device 110 may be the same or different from the processing unit 710.

The electronic device 700 usually includes various computer storage medium. Such computer storage medium may be any available medium accessible by the electronic device 700, including but not limited to, a volatile and non-volatile medium, or a detachable and non-detachable medium. The memory 720 may comprise a volatile memory (for example, a register, a cache, a random access memory (RAM)), a non-volatile memory (for example, a read-only memory (ROM), an electrically erasable programmable read-only memory (EEPROM), a flash memory), or any combination thereof. The storage device 730 may comprise a detachable or non-detachable medium and may include a computer-readable medium such as a memory, a flash drive, a magnetic disk or any other medium, which can be used for storing information and/or data and be accessed in the electronic device 700.

The electronic device 700 may further include additional detachable/non-detachable, volatile/non-volatile memory medium. Although not shown in FIG. 7, it is possible to provide a disk drive for reading from or writing into a detachable and non-volatile disk and an optical disc drive for reading from and writing into a detachable non-volatile optical disc. In such cases, each drive may be connected to a bus (not shown) via one or more data medium interfaces.

The communication unit 740 communicates with a further electronic device via a communication medium. In addition, the functions of components in the electronic device 700 may be implemented by a single computing cluster or a plurality of computing machines that can communicate via communication connections. Therefore, the electronic device 700 can operate in a networked environment using a logical connection with one or more other servers, personal computers (PCs) or other general network nodes.

The input device 750 may include one or more of various input devices, such as a mouse, a keyboard, a data input device, and the like. The output device 760 may include one or more of various output devices, such as a display, a data output device, and the like. By means of the communication unit 740, the electronic device 700 may further communicate with one or more external devices (not shown) such as the storage devices and display devices, with one or more devices enabling a user to interact with the electronic device 700, or with any devices (such as a network card, a modem, and the like) enabling the electronic device 700 to communicate with one or more other electronic devices, if required. Such communication may be performed via input/output (I/O) interfaces (not shown).

In some implementations, as an alternative of being integrated on a single device, some or all components of the electronic device 700 may also be arranged in the form of a cloud computing architecture. In the cloud computing architecture, the components may be provided remotely and work together to implement the functions described in the subject matter described herein. In some implementations, cloud computing provides computing, software, data access and storage services, which will not require end users to be aware of the physical locations or configurations of the systems or hardware providing these services. In various implementations, the cloud computing provides the services via a wide area network (such as Internet) using proper protocols. For example, a cloud computing provider provides applications over the wide region network, which can be accessed through a web browser or any other computing components. The software or components of the cloud computing architecture and corresponding data may be stored on a server at a remote location. The computing resources in the cloud computing environment may be merged at locations of remote data centers or may be distributed. Cloud computing infrastructures may provide the services through a shared data center, though they behave as a single access point for users. Therefore, the cloud computing architecture may be used to provide the components and functions described herein from a service provider at a remote location. Alternatively, they may be provided from a conventional server or installed directly or otherwise on a client device.

The electronic device 700 may be used to implement multiple implementations of the present disclosure. The memory 720 may include one or more modules having one or more program instructions. These modules can be accessed and executed by the processing unit 710 to perform functions of various implementations described herein. For example, the memory 720 may include a tensor processing module 722 for processing target operations associated with the target tensor. As shown in FIG. 7, the electronic device 700 may obtain input to be processed by tensors through the input device 750, and may provide output processed by tensors through the output device 760. In some implementations, the electronic device 700 may further receive input from other devices (not shown) via the communication unit 740.

### Example Implementations

Some example implementations of the present disclosure are listed below.

In one aspect, a method of computer implementation is provided by the present disclosure. The method comprises determining, based on a size of a target tensor, a target window size for performing a target operation associated with the target tensor on a processing device; determining at least one data block based on the target window size and the target tensor, a set of elements comprised in the at least one data block covering at least the target tensor; and for each data block in the at least one data block, performing at least one of a plurality of predetermined tasks corresponding to the target operation and the target window size based on a position of each element of the data block in the target tensor, the plurality of predetermined tasks being precompiled for the processing device to perform the target operation on a tensor with the target window size.

In some implementations, performing at least one of the plurality of predetermined tasks comprises determining whether the data block comprises an element crossing a predetermined boundary associated with the target tensor; and in response to determining that the data block does not comprise an element crossing the predetermined boundary, performing, for the data block, a vectorized first predetermined task of the plurality of predetermined tasks.

In some implementations, the method further comprises: in response to determining that the data block comprises an element crossing the predetermined boundary, dividing the data block into a first subblock that does not cross the predetermined boundary and a second subblock crossing the predetermined boundary; performing, for the first subblock, a vectorized second predetermined task of the plurality of predetermined tasks, wherein a vectorization degree of the second predetermined task is less than a vectorization degree of the first predetermined task; and performing, for the second subblock, a non-vectorized third predetermined task of the plurality of predetermined tasks.

In some implementations, the predetermined boundary divides the target tensor into different portions, and the method further comprises selecting, from the plurality of predetermined tasks, the first predetermined task corresponding to a portion where the data block is located.

In some implementations, the predetermined boundary comprises at least one of: a border of the target tensor, a boundary associated with distribution of values of elements in the target tensor, or a boundary for distinguishing predetermined operations applied by the target operation to elements in the target tensor.

In some implementations, the method further comprises: dividing the at least one data block into at least a first group of data blocks and a second group of data blocks; launching performing, for the first group of data blocks, at least one of the plurality of predetermined tasks respectively; launching asynchronous transmission of respective execution results of the first group of data blocks to a further processing device; while the asynchronous transmission, launching performing, for the second group of data blocks, at least one of the plurality of predetermined tasks respectively; and launching asynchronous transmission of respective execution results of the second group of data blocks to the further processing device.

In some implementations, determining the target window size comprises selecting, based on the size of the target tensor, a sampling tensor size from a plurality of sampling tensor sizes, wherein optimized window sizes are predetermined for the plurality of sampling tensor sizes respectively; and determining an optimized window size predetermined for the selected sampling tensor size as the target window size.

In some implementations, selecting the sampling tensor size from the plurality of sampling tensor sizes is further based on at least one of the following parameters associated with the processing device and the target operation: a first parameter indicating a tensor size corresponding to a change in a sampling interval of the plurality of sampling tensor sizes, or a second parameter indicating a maximum tensor size of the plurality of sampling tensor sizes.

In some implementations, an optimized window size for each sampling tensor size of the plurality of sampling tensor sizes is determined by: determining, for each candidate window size of a plurality of candidate window sizes, throughput by performing, at the candidate window size, the target operation for a tensor with the sampling tensor size; and selecting, based on the throughput determined respectively for the plurality of candidate window sizes, the optimized window size for the sampling tensor size from the plurality of candidate window sizes.

In a further aspect, an electronic device is provided by the present disclosure. The electronic device comprises a processing unit; and a memory coupled to the processing unit and comprises instructions stored thereon, the instructions, when executed by the processing unit, causing the device to execute the following acts. The acts comprise determining, based on a size of a target tensor, a target window size for performing a target operation associated with the target tensor on a processing device; determining at least one data block based on the target window size and the target tensor, a set of elements comprised in the at least one data block covering at least the target tensor; and for each data block in the at least one data block, performing at least one of a plurality of predetermined tasks corresponding to the target operation and the target window size based on a position of each element of the data block in the target tensor, the plurality of predetermined tasks being precompiled for the processing device to perform the target operation on a tensor with the target window size.

In some implementations, performing at least one of the plurality of predetermined tasks comprises: determining whether the data block comprises an element crossing a predetermined boundary associated with the target tensor; and in response to determining that the data block does not comprise an element crossing the predetermined boundary, performing, for the data block, a vectorized first predetermined task of the plurality of predetermined tasks.

In some implementations, the acts further comprises: in response to determining that the data block comprises an element crossing the predetermined boundary, dividing the data block into a first subblock that does not cross the predetermined boundary and a second subblock crossing the predetermined boundary; performing, for the first subblock, a vectorized second predetermined task of the plurality of predetermined tasks, wherein a vectorization degree of the second predetermined task is less than a vectorization degree of the first predetermined task; and performing, for the second subblock, a non-vectorized third predetermined task of the plurality of predetermined tasks.

In some implementations, the predetermined boundary divides the target tensor into different portions, and the acts further comprises selecting, from the plurality of predetermined tasks, the first predetermined task corresponding to a portion where the data block is located.

In some implementations, the predetermined boundary comprises at least one of: a border of the target tensor, a boundary associated with distribution of values of elements in the target tensor, or a boundary for distinguishing predetermined operations applied by the target operation to elements in the target tensor.

In some implementations, the acts further comprises: dividing the at least one data block into at least a first group of data blocks and a second group of data blocks; launching performing, for the first group of data blocks, at least one of the plurality of predetermined tasks respectively; launching asynchronous transmission of respective execution results of the first group of data blocks to a further processing device; while the asynchronous transmission, launching performing, for the second group of data blocks, at least one of the plurality of predetermined tasks respectively; and launching asynchronous transmission of respective execution results of the second group of data blocks to the further processing device.

In some implementations, determining the target window size comprises selecting, based on the size of the target tensor, a sampling tensor size from a plurality of sampling tensor sizes, wherein optimized window sizes are predetermined for the plurality of sampling tensor sizes respectively; and determining an optimized window size predetermined for the selected sampling tensor size as the target window size.

In some implementations, selecting the sampling tensor size from the plurality of sampling tensor sizes is further based on at least one of the following parameters associated with the processing device and the target operation: a first parameter indicating a tensor size corresponding to a change in a sampling interval of the plurality of sampling tensor sizes, or a second parameter indicating a maximum tensor size of the plurality of sampling tensor sizes.

In some implementations, an optimized window size for each sampling tensor size of the plurality of sampling tensor sizes is determined by: determining, for each candidate window size of a plurality of candidate window sizes, throughput by performing, at the candidate window size, the target operation for a tensor with the sampling tensor size; and selecting, based on the throughput determined respectively for the plurality of candidate window sizes, the optimized window size for the sampling tensor size from the plurality of candidate window sizes.

In a further aspect, a computer program product is provided by the present disclosure. The computer program product is tangibly stored on a non-transient computer readable medium and comprises machine executable instructions, the machine executable instructions, when executed, causing a machine to perform acts. The acts comprise determining, based on a size of a target tensor, a target window size for performing a target operation associated with the target tensor on a processing device; determining at least one data block based on the target window size and the target tensor, a set of elements comprised in the at least one data block covering at least the target tensor; and for each data block in the at least one data block, performing at least one of a plurality of predetermined tasks corresponding to the target operation and the target window size based on a position of each element of the data block in the target tensor, the plurality of predetermined tasks being precompiled for the processing device to perform the target operation on a tensor with the target window size.

In some implementations, performing at least one of the plurality of predetermined tasks comprises: determining whether the data block comprises an element crossing a predetermined boundary associated with the target tensor; and in response to determining that the data block does not comprise an element crossing the predetermined boundary, performing, for the data block, a vectorized first predetermined task of the plurality of predetermined tasks.

In some implementations, the acts further comprises: in response to determining that the data block comprises an element crossing the predetermined boundary, dividing the data block into a first subblock that does not cross the predetermined boundary and a second subblock crossing the predetermined boundary; performing, for the first subblock, a vectorized second predetermined task of the plurality of predetermined tasks, wherein a vectorization degree of the second predetermined task is less than a vectorization degree of the first predetermined task; and performing, for the second subblock, a non-vectorized third predetermined task of the plurality of predetermined tasks.

In some implementations, the predetermined boundary divides the target tensor into different portions, and the acts further comprises selecting, from the plurality of predetermined tasks, the first predetermined task corresponding to a portion where the data block is located.

In some implementations, the predetermined boundary comprises at least one of: a border of the target tensor, a boundary associated with distribution of values of elements in the target tensor, or a boundary for distinguishing predetermined operations applied by the target operation to elements in the target tensor.

In some implementations, the acts further comprises: dividing the at least one data block into at least a first group of data blocks and a second group of data blocks; launching performing, for the first group of data blocks, at least one of the plurality of predetermined tasks respectively; launching asynchronous transmission of respective execution results of the first group of data blocks to a further processing device; while the asynchronous transmission, launching performing, for the second group of data blocks, at least one of the plurality of predetermined tasks respectively; and launching asynchronous transmission of respective execution results of the second group of data blocks to the further processing device.

In some implementations, determining the target window size comprises selecting, based on the size of the target tensor, a sampling tensor size from a plurality of sampling tensor sizes, wherein optimized window sizes are predetermined for the plurality of sampling tensor sizes respectively; and determining an optimized window size predetermined for the selected sampling tensor size as the target window size.

In some implementations, selecting the sampling tensor size from the plurality of sampling tensor sizes is further based on at least one of the following parameters associated with the processing device and the target operation: a first parameter indicating a tensor size corresponding to a change in a sampling interval of the plurality of sampling tensor sizes, or a second parameter indicating a maximum tensor size of the plurality of sampling tensor sizes. In some implementations, an optimized window size for each sampling tensor size of the plurality of sampling tensor sizes is determined by: determining, for each candidate window size of a plurality of candidate window sizes, throughput by performing, at the candidate window size, the target operation for a tensor with the sampling tensor size; and selecting, based on the throughput determined respectively for the plurality of candidate window sizes, the optimized window size for the sampling tensor size from the plurality of candidate window sizes.

In a further aspect, a computer-readable medium is provided by the present disclosure. The computer-readable medium has machine-executable instructions stored thereon which, when executed by a device, cause the device to perform one or more example implementations of the methods of the aforementioned aspects.

The functionality described herein can be performed, at least in part, by one or more hardware logic components. For example, and without limitation, example types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or a server.

In the context of this subject matter described herein, a machine-readable medium may be any tangible medium that may contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the particular order shown or in a sequential order, or all operations shown are required to be executed to achieve the expected results. In certain circumstances, multitasking and parallel processing may be advantageous. Likewise, while several specific implementation details are contained in the above discussions, these should not be construed as limitations on the scope of the subject matter described herein. Certain features that are described in the context of separate implementations may also be implemented in combination in a single implementation. Conversely, various features that are described in the context of a single implementation may also be implemented in multiple implementations separately or in any suitable sub-combination.

Although the subject matter described herein has been described in language specific to structural features and/or methodological acts, it is to be understood that the subject matter described herein specified in the appended claims is not necessarily limited to the specific features or acts described above. Rather, the specific features and acts described above are disclosed as example forms of implementing the claims.

1.-15. (canceled)

16. A method of computer implementation, comprising:
determining, based on a size of a target tensor, a target window size for performing a target operation associated with the target tensor on a processing device;
determining at least one data block based on the target window size and the target tensor, a set of elements comprised in the at least one data block covering at least the target tensor; and
for each data block in the at least one data block, performing at least one of a plurality of predetermined tasks corresponding to the target operation and the target window size based on a position of each element of the data block in the target tensor, the plurality of predetermined tasks being precompiled for the processing device to perform the target operation on a tensor with the target window size.

17. The method of claim 16, wherein performing at least one of the plurality of predetermined tasks comprises:
determining whether the data block comprises an element crossing a predetermined boundary associated with the target tensor; and
in response to determining that the data block does not comprise an element crossing the predetermined boundary, performing, for the data block, a vectorized first predetermined task of the plurality of predetermined tasks.

18. The method of claim 17, further comprising:
in response to determining that the data block comprises an element crossing the predetermined boundary, dividing the data block into a first subblock that does not cross the predetermined boundary and a second subblock crossing the predetermined boundary;
performing, for the first subblock, a vectorized second predetermined task of the plurality of predetermined tasks, wherein a vectorization degree of the second predetermined task is less than a vectorization degree of the first predetermined task; and
performing, for the second subblock, a non-vectorized third predetermined task of the plurality of predetermined tasks.

19. The method of claim 17, wherein the predetermined boundary divides the target tensor into different portions, and the method further comprises:
selecting, from the plurality of predetermined tasks, the first predetermined task corresponding to a portion where the data block is located.

20. The method of claim 17, wherein the predetermined boundary comprises at least one of:
a border of the target tensor,
a boundary associated with distribution of values of elements in the target tensor, or
a boundary for distinguishing predetermined operations applied by the target operation to elements in the target tensor.

21. The method of claim 16, further comprising:
dividing the at least one data block into at least a first group of data blocks and a second group of data blocks;
launching performing, for the first group of data blocks, at least one of the plurality of predetermined tasks respectively;
launching asynchronous transmission of respective execution results of the first group of data blocks to a further processing device;
while the asynchronous transmission, launching performing, for the second group of data blocks, at least one of the plurality of predetermined tasks respectively; and
launching asynchronous transmission of respective execution results of the second group of data blocks to the further processing device.

22. The method of claim 16, wherein determining the target window size comprises:
selecting, based on the size of the target tensor, a sampling tensor size from a plurality of sampling tensor sizes, wherein optimized window sizes are predetermined for the plurality of sampling tensor sizes respectively; and
determining an optimized window size predetermined for the selected sampling tensor size as the target window size.

23. The method of claim 22, wherein selecting the sampling tensor size from the plurality of sampling tensor sizes is further based on at least one of the following parameters associated with the processing device and the target operation:
a first parameter indicating a tensor size corresponding to a change in a sampling interval of the plurality of sampling tensor sizes, or
a second parameter indicating a maximum tensor size of the plurality of sampling tensor sizes.

24. The method of claim 22, wherein an optimized window size for each sampling tensor size of the plurality of sampling tensor sizes is determined by:
determining, for each candidate window size of a plurality of candidate window sizes, throughput by performing, at the candidate window size, the target operation for a tensor with the sampling tensor size; and
selecting, based on the throughput determined respectively for the plurality of candidate window sizes, the optimized window size for the sampling tensor size from the plurality of candidate window sizes.

25. An electronic device, comprising:
a processing unit; and
a memory coupled to the processing unit and comprising instructions stored thereon, the instructions, when executed by the processing unit, causing the device to perform acts comprising:
determining, based on a size of a target tensor, a target window size for performing a target operation associated with the target tensor on a processing device;
determining at least one data block based on the target window size and the target tensor, a set of elements comprised in the at least one data block covering at least the target tensor; and
for each data block in the at least one data block, performing at least one of a plurality of predetermined tasks corresponding to the target operation and the target window size based on a position of each element of the data block in the target tensor, the plurality of predetermined tasks being precompiled for the processing device to perform the target operation on a tensor with the target window size.

26. The device of claim 25, wherein performing at least one of the plurality of predetermined tasks comprises:
determining whether the data block comprises an element crossing a predetermined boundary associated with the target tensor; and
in response to determining that the data block does not comprise an element crossing the predetermined boundary, performing, for the data block, a vectorized first predetermined task of the plurality of predetermined tasks.

27. The device of claim 26, the acts further comprising:
in response to determining that the data block comprises an element crossing the predetermined boundary, dividing the data block into a first subblock that does not cross the predetermined boundary and a second subblock crossing the predetermined boundary;
performing, for the first subblock, a vectorized second predetermined task of the plurality of predetermined tasks, wherein a vectorization degree of the second predetermined task is less than a vectorization degree of the first predetermined task; and
performing, for the second subblock, a non-vectorized third predetermined task of the plurality of predetermined tasks.

28. The device of claim 26, wherein the predetermined boundary divides the target tensor into different portions, and the acts further comprise:
selecting, from the plurality of predetermined tasks, the first predetermined task corresponding to a portion where the data block is located.

29. The device of claim 26, wherein the predetermined boundary comprises at least one of:
a border of the target tensor,
a boundary associated with distribution of values of elements in the target tensor, or
a boundary for distinguishing predetermined operations applied by the target operation to elements in the target tensor.

30. The device of claim 25, wherein the acts further comprise:
dividing the at least one data block into at least a first group of data blocks and a second group of data blocks;
launching performing, for the first group of data blocks, at least one of the plurality of predetermined tasks respectively;
launching asynchronous transmission of respective execution results of the first group of data blocks to a further processing device;
while the asynchronous transmission, launching performing, for the second group of data blocks, at least one of the plurality of predetermined tasks respectively; and
launching asynchronous transmission of respective execution results of the second group of data blocks to the further processing device.

31. The device of claim 25, wherein determining the target window size comprises:
selecting, based on the size of the target tensor, a sampling tensor size from a plurality of sampling tensor sizes, wherein optimized window sizes are predetermined for the plurality of sampling tensor sizes respectively; and
determining an optimized window size predetermined for the selected sampling tensor size as the target window size.

32. The device of claim 31, wherein selecting the sampling tensor size from the plurality of sampling tensor sizes is further based on at least one of the following parameters associated with the processing device and the target operation:
a first parameter indicating a tensor size corresponding to a change in a sampling interval of the plurality of sampling tensor sizes, or
a second parameter indicating a maximum tensor size of the plurality of sampling tensor sizes.

33. The device of claim 31, wherein an optimized window size for each sampling tensor size of the plurality of sampling tensor sizes is determined by:
determining, for each candidate window size of a plurality of candidate window sizes, throughput by performing, at the candidate window size, the target operation for a tensor with the sampling tensor size; and
selecting, based on the throughput determined respectively for the plurality of candidate window sizes, the optimized window size for the sampling tensor size from the plurality of candidate window sizes.

34. A computer program product tangibly stored in a computer storage medium and comprising computer executable instructions that, when executed by a device, cause the device to perform acts comprising:
determining, based on a size of a target tensor, a target window size for performing a target operation associated with the target tensor on a processing device;
determining at least one data block based on the target window size and the target tensor, a set of elements comprised in the at least one data block covering at least the target tensor; and
for each data block in the at least one data block, performing at least one of a plurality of predetermined tasks corresponding to the target operation and the target window size based on a position of each element of the data block in the target tensor, the plurality of predetermined tasks being precompiled for the processing device to perform the target operation on a tensor with the target window size.

35. The computer program product of claim 34, wherein performing at least one of the plurality of predetermined tasks comprises:
determining whether the data block comprises an element crossing a predetermined boundary associated with the target tensor; and
in response to determining that the data block does not comprise an element crossing the predetermined boundary, performing, for the data block, a vectorized first predetermined task of the plurality of predetermined tasks.
